(19) United States
(12) Patent Application Publication
(10) Pub. No.: US 2013/0247182 A1
(43) Pub. Date: Sep. 19, 2013

(54) SYSTEM, METHOD, AND COMPUTER PROGRAM PRODUCT FOR IDENTIFYING HIDDEN OR MODIFIED DATA OBJECTS

(71) Applicants: Seagen James Levites, Beaverton, OR (US); Rachit Mathur, Hillsboro, OR (US); Aditya Kapoor, Beaverton, OR (US)

(72) Inventors: Seagen James Levites, Beaverton, OR (US); Rachit Mathur, Hillsboro, OR (US); Aditya Kapoor, Beaverton, OR (US)

(21) Appl. No.: 12/427,463

(22) Filed: Apr. 21, 2009

(51) Int. Cl. G06F 21/00; G06F 17/30; G06F 15/177; G06F 12/14; H04L 29/06

(52) U.S. Cl. 726/22; 713/2; 707/E17.055; 707/697

(57) ABSTRACT

A system, method, and computer program product are provided for detecting hidden or modified data objects. In use, a first set of data objects stored in a device is enumerated, where the enumeration of the first set of data objects is performed within an operating system of the device. Additionally, a second set of data objects stored in the device is enumerated, where the enumeration of the second set of data objects is performed outside of the operating system of the device. Further, the first set of data objects and the second set of data objects are compared for identifying hidden or modified data objects.

### FIELD OF THE INVENTION

The present invention relates to hidden and modified data objects, and more particularly to identifying hidden or modified data objects.

### BACKGROUND

Some techniques allow data objects to be hidden or modified from an operating system in an undetectable manner. Unfortunately, such techniques are often times employed for malicious purposes. For example, unwanted data (e.g. rootkits, etc.) may be hidden or modified in an undetectable manner to prevent detection thereof by a security system. Accordingly, traditional security systems have generally been ineffective and/or inefficient in detecting data that is hidden or modified utilizing the aforementioned techniques.

There is thus a need for addressing these and/or other issues associated with the prior art.

### SUMMARY

A system, method, and computer program product are provided for detecting hidden or modified data objects. In use, a first set of data objects stored in a device is enumerated, where the enumeration of the first set of data objects is performed within an operating system of the device. Additionally, a second set of data objects stored in the device is enumerated, where the enumeration of the second set of data objects is performed outside of the operating system of the device. Further, the first set of data objects and the second set of data objects are compared for identifying hidden or modified data objects.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 illustrates a method for identifying hidden or modified data objects, in accordance with one embodiment.

FIG. 4 illustrates a method for identifying and reporting suspicious data objects, in accordance with another embodiment.

FIG. 5A illustrates a first set of data objects, in accordance with yet another embodiment.

FIG. 5B illustrates a second set of data objects, in accordance with still yet another embodiment.

FIG. 5C illustrates a comparison of a second set of data objects with a first set of data objects, in accordance with another embodiment.

FIG. 5D illustrates a result of comparing a second set of data objects with a first set of data objects, in accordance with yet another embodiment.

### DETAILED DESCRIPTION

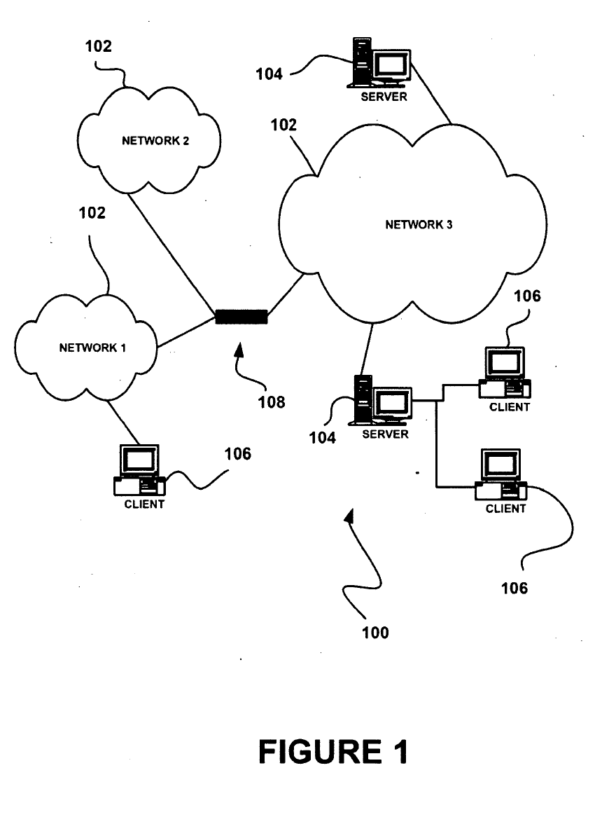

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

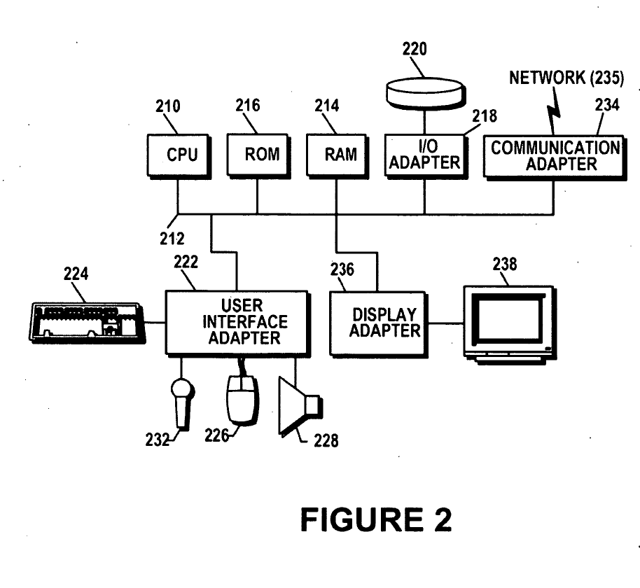

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

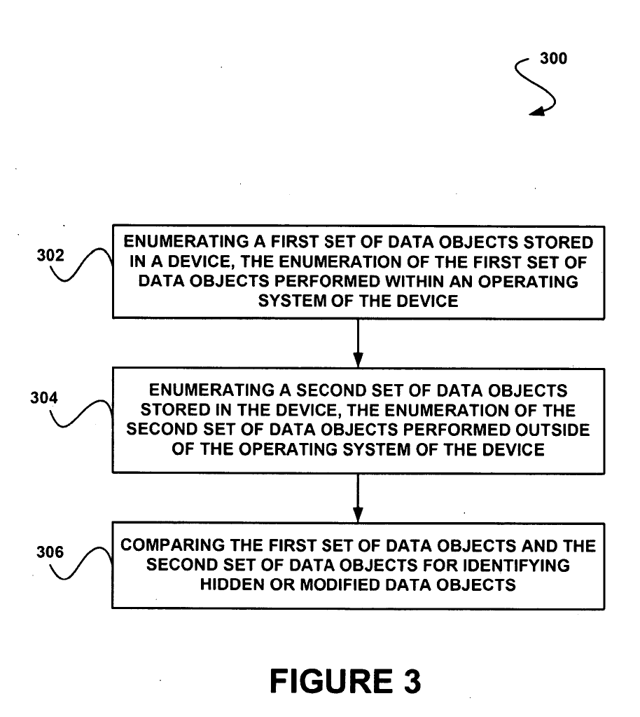

FIG. 3 illustrates a method 300 for identifying hidden or modified data objects, in accordance with one embodiment. As an option, the method 300 may be carried out in the context of the architecture and environment of FIGS. 1 and/or 2. Of course, however, the method 300 may be carried out in any desired environment.

As shown in operation 302, a first set of data objects stored in a device is enumerated, where the enumeration of the first set of data objects is performed within an operating system of the device. In the context of the present description, the data objects may include any object associated with data. Optionally, the data objects may include files, file contents, directories, a registry, etc. For example, the files may be associated with an operating system, an application, a process, data, etc. As yet another option, the files may include a driver, a library, a dynamic link library, an executable, a portable executable, an application, application data, a registry, a configuration, user data, etc.

Further, in another embodiment, the first set of data objects may include any list, group, collection, etc. of the data objects. Optionally, the first set of data objects may be stored in any portion of the device. As an example, the first set of data objects may be stored on disk storage units 220, as shown in FIG. 2. Additionally, as an example, the disk storage units may include a disk image, a hard disk drive, a removable storage drive, a floppy disk drive, a magnetic tape drive, a compact disk drive, a universal serial bus (USB) drive, a memory card, an optical drive, optical media, magnetic media, etc. In addition, the first set of data objects may be stored in a network data store, a database, a central storage repository, etc.

In yet another embodiment, the device may include any servers 104, clients 106, gateways 108, etc. as illustrated in FIG. 1. As an option, the enumeration of the first set of data objects may include cataloging, identifying, itemizing, listing, etc. the data objects stored in the device. The enumeration of the first set of data objects may be performed in any manner which results in the enumeration of the first set of data objects stored in the device. Optionally, the enumeration of the first set of data objects may be performed utilizing a data object listing, a stream, a bit listing, a sector listing, etc. For example, a directory list command may be utilized to perform the enumeration of the data objects stored in the device. As another example, each data object stored on the device may be hashed to provide a hash listing of each of the data objects.

Moreover, as noted above, the enumeration of the first set of data objects is performed within the operating system of the device. Optionally, the operating system may include an operating system currently executing on the device. As another option, the operating system may include any operating system capable of being utilized by the device. Furthermore, the operating system may include various functionality, such as a graphical user interface (GUI), drivers, a kernel, a registry, an application program interface (API), commands, etc.

Additionally, as an option, the enumeration of the first set of data objects may be performed within the operating system such that the enumeration of the first set of data objects utilizes the commands, the APIs, the drivers, etc. of the operating system. Still yet, the enumeration of the first set of data objects may be performed within the operating system such that the enumeration of the first set of data objects utilizes user mode APIs associated with the operating system. Of course, however, enumerating the first set of data objects within the operating system may include performing any enumeration of the first set of data objects in a manner that utilizes the operating system.

As shown in operation 304, a second set of data objects stored in the device is enumerated, where the enumeration of the second set of data objects is performed outside of the operating system of the device. In one embodiment, the second set of data objects may include any list, group, collection, etc. of the data objects stored in the device.

It should be noted that enumerating the second set of data objects outside of the operating system may include performing any enumeration of the second set of data objects in a manner that does not necessarily utilize the operating system. Thus, for example, the first set of data objects may be enumerating utilizing the operating system, and the second set of data objects may be enumerating without utilizing the operating system. Optionally, performing the enumeration outside of the operating system of the device may include utilizing another operating system (e.g. different from the operating system mentioned above with respect to operation 302) to enumerate the second set of data objects.

As another option, the other operating system may include a verified operating system, a known clean operating system, a lightweight operating system, etc. For example, the lightweight operating system may not necessarily include a GUI, peripheral drivers (e.g. printer drivers, web camera drivers, mouse drivers, Bluetooth drivers, etc.), accessory applications (e.g. games, network browser, email client, etc.), etc. As yet another option, the other operating system may be capable of reading and/or writing any storage format associated with a disk storage unit of the device. For example, the other operating system may be capable of reading and/or writing storage formats including FAT, NTFS, HFS, HFS+, HPFS, ext2, ext3, ext4, XFS, JFS, ReiserFS, etc. Additionally, as an option, the other operating system may be included in a disk storage unit of the device, a network accessible storage, a disk image, etc.

In another embodiment, performing the enumeration outside of the operating system of the device may include enumerating the second set of data objects within an environment outside of the operating system of the device. For example, in response to the enumeration of the first set of data objects, an environment outside of the operating system of the device may be automatically booted. As an option, the environment outside of the operating system of the device may be automatically booted to perform the enumeration of the second set of data objects.

As another option, a boot loader may be utilized to automatically boot the environment outside of the operating system. Optionally, the environment outside of the operating system of the device may be automatically booted by overwriting a master boot record of the device. For example, overwriting the master boot record may allow the device to automatically boot the environment outside of the operating system. As an option, the environment outside of the operating system of the device may be booted utilizing a network. For example, booting utilizing the network may include loading the other operating system utilizing the network. As yet another example, the boot loader may automatically overwrite the master boot record and reboot the device after completing the enumerating and the storing of the first set of data objects.

In yet another embodiment, performing the enumeration of the second set of data objects outside of the operating system may include performing the enumeration of the second set of data objects within the other operating system. Optionally, the enumeration of the second set of data objects may be performed utilizing commands, APIs, drivers, etc. of the other operating system.

In still yet another embodiment, the first set of data objects and the second set of data objects may each be enumerated by scanning data objects of the device. Optionally, such scanning may include any scanning of the data objects of the device. For example, the scanning may include listing the data objects, gathering information associated with the data objects, hashing information associated with the data objects, copying the data objects, etc.

In one embodiment, the enumeration of the first set of data objects and the enumeration of the second set of data objects may be performed at a predetermined level of abstraction of the device. Optionally, the predefined level of abstraction may include a directory level. As an example, the first set of data objects may include a first set of directories of the device and the second set of data objects each may include a second set of directories of the device. As an option, the predefined level of abstraction may include a sector level. For example, the first set of data objects may include a first set of sectors of the device and the second set of data objects may include a second set of sectors of the device. Still, as yet another option, the predefined level of abstraction may include a bit level. As an example, the first set of data objects may include a first set of bits of the device and the second set of data objects may include a second set of bits of the device.

As shown in operation 306, the first set of data objects and the second set of data objects are compared for identifying hidden or modified data objects. In one embodiment, the comparing may include analyzing, correlating, differencing, examining, inspecting, performing a delta, etc. For example, the comparison may include performing a difference between the first set of data objects and the second set of data objects. Optionally, the comparison may be performed outside of the operating system of the device. For example, the other operating system may perform the comparison of the first set of data objects and the second set of data objects. Of course, however, the comparison may be performed in any manner that is capable of identifying hidden or modified data objects.

As noted above, the comparison is utilized for identifying the hidden or modified data objects. Optionally, the hidden data objects may include data objects present in one set of data but not the other. For example, the hidden data objects may be included in the second set of data objects and may be missing in the first set of data objects. As yet another example, the hidden data objects may include data objects that are hidden from the operating system. As another option, the modified data objects may include data objects that are different in the second set of data objects and the first set of data objects. As an example, a modified data object in the first set of data objects may have at least one characteristic that is different from a corresponding data object in the second set of data objects.

In one exemplary embodiment, potentially unwanted data objects may be identified if it is determined, based on the comparison, that the first set of data objects is different from the second set of data objects. Further, as an option, the potentially unwanted data objects may include data objects that are different between the first set of data objects and the second set of data objects.

In still yet another embodiment, the potentially unwanted data objects may be scanned with signatures of known unwanted data. As an option, the scanning may determine whether the potentially unwanted data objects are unwanted. For example, the signatures may include any pattern, heuristic, identifier, hash, checksum, etc. capable of being utilized to determine whether the potentially unwanted data objects are unwanted.

Additionally, in one embodiment, the potentially unwanted data objects may be reported. Optionally, only the unwanted data objects identified as a result of the determination may be reported. For example, the reporting may include any alert, communication, disclosure, summary, of the unwanted data objects, the potentially unwanted data objects, etc. Still yet, as another option, the reporting may exclude the potentially unwanted data objects that are of a predetermined type. As an option, the predetermined type may include cached data objects, temporary data objects, known data objects, etc.

In another embodiment, the operating system of the device may be automatically booted based on the comparison. As an option, the master boot record associated with the device may be overwritten to allow the device to automatically boot the operating system. Further, as yet another option, after overwriting the master boot record, the device may be rebooted.

Further, in another embodiment, the enumerating of the first set of data objects, tile enumerating of the second set of data objects, and/or the comparison may be performed by a security system. As an option, the security system may include a scanner, a virus scanner, a rootkit scanner, a malware scanner, etc. In addition, as yet another option, the security system may be capable of executing within the operating system and outside of the operating system. Optionally, a vendor associated with the security system may also be associated with (e.g. may provide, may have developed, etc.) the other operating system.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

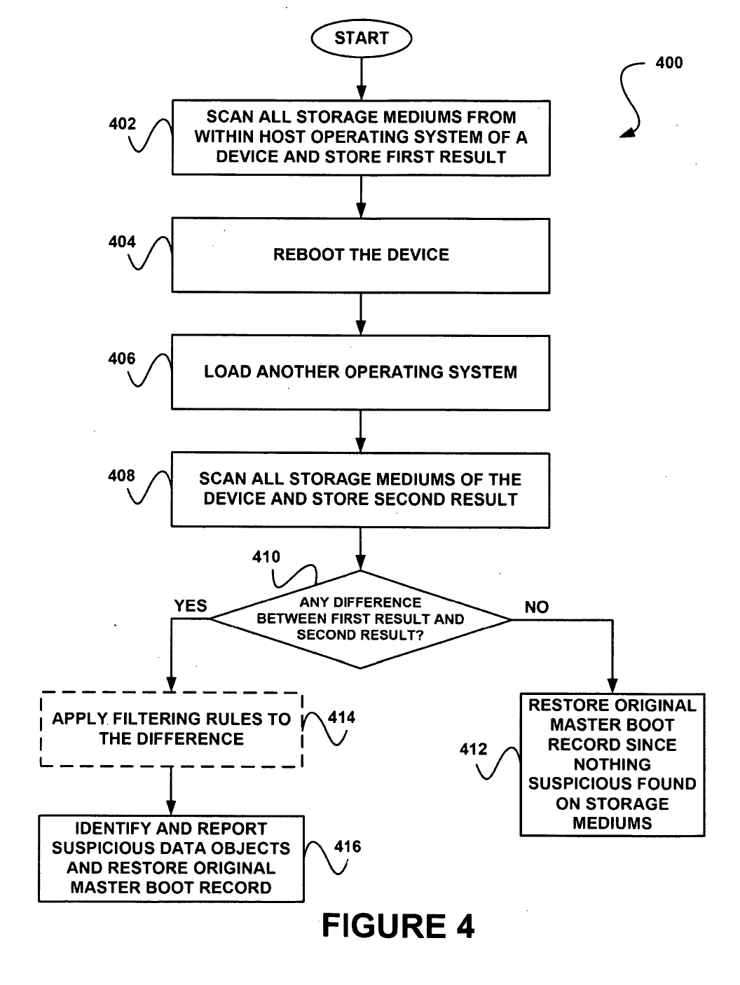

FIG. 4 illustrates a method for identifying and reporting suspicious data objects, in accordance with another embodiment. As an option, the method 400 may be carried in the context of the architecture and environment of FIGS. 1-3. Of course, however, the method 400 may be carried out in any desired environment. It should also be noted that the aforementioned definitions may apply during the present description.

As shown in operation 402, all storage mediums are scanned from within a host operating system of a device and a first result is stored. As an option, the storage mediums may be associated with the device. Optionally, the storage mediums may include any of the disk storage units as described in FIG. 3, etc. In yet another embodiment, the scanning may include listing files and directories of the storage mediums, determining attributes associated with the files and the directories, generating a checksum and/or hash associated with each file, parsing a registry associated with the host operating system, checking inside the files, etc.

Further, in one embodiment, the scanning of the storage mediums may generate the first result. For example, the first result may include a listing of the files, the directories, the file attributes, the directory attributes, the hashes associated with the files, etc. Additionally, as an option, the first result may be stored on one of the scanned storage mediums, an additional storage medium associated with the device (e.g. an unscanned storage medium), a network storage medium, a central repository, a storage medium associated with another device, etc.

In another embodiment, after the first result is stored, the master boot record associated with the device may be updated. As an option, the master boot record may be updated to indicate that another operating system different from the host operating system should be executed after a next reboot of the device. For example, the other operating system may be a different type of operating system from the host operating system, a known clean operating system, etc. As yet another option, a dynamic boot loader may be referenced and/or utilized by the master boot record. Optionally, after a reboot, the master boot record may indicate such reboot to the dynamic boot loader to initiate the loading of the other operating system.

In addition, the device is rebooted. See operation 404. Optionally, after the master boot record is updated, the host operating system of the device may be shutdown. As another option, the device may be rebooted after the master boot record is updated and/or the host operating system of the device completes the shutdown. Still, as yet another option, after the rebooting, the device may read the master boot record to determine which operating system to load.

Further, as shown in operation 406, another operating system is loaded. Optionally, the other operating system may be loaded as indicated by the master boot record. For example, the other operating system may be loaded utilizing a network boot from a server via a network, a compact disk, an external hard disk, a disk image, etc.

Additionally, as shown in operation 408, all of the storage mediums of the device are scanned and a second result is stored. As an option, after the other operating system finishes loading, the scanning of all of the storage mediums of the device may be automatically started. For example, automatically starting the scan may include starting the scan without input from a user. Furthermore, as still yet another option, the second result may be stored after the scan completes.

Still yet, as shown in decision 410, it is determined if there is any difference between the first result and the second result. In one embodiment, the first result and the second result are compared. Optionally, the comparison may be performed within the other operating system of the device. As yet another option, the comparison may generate a diff, a delta, etc. of the second result and the first result. Still, as another option, the determination of whether there is any difference may be automatically started after the second result is stored.

As shown in operation 412, if it is determined that there is not a difference between the first result and the second result, the original master boot record is restored since nothing suspicious was found on the storage mediums. For example, determining that a different between the first result and the second result is nonexistent may result in a determination that nothing suspicious was found on the storage mediums. Optionally, restoring the original master boot record may include updating the master boot record to load the host operating system after the next reboot. Further, as yet another option, after the original master boot record is restored, the device is rebooted in order to initiate the loading of the host operating system.

As shown in operation 414, if it is determined that there is a difference between the first result and the second result, filtering rules may optionally be applied to the difference. Optionally, if there are differences, then the filtering rules may be applied to the difference to remove any results that match the filtering rules.

Furthermore, as an option, the filtering rules may be based on an exclusion file. As another option, the exclusion file may include a list of rules, files, directories, file extensions, file names, registry keys, cache files, temporary files, etc. to filter from the difference. Optionally, the exclusion file may include a database. For example, the exclusion file may include registry keys that are written during a reboot.

Additionally, in yet another embodiment, signatures (e.g. of the filtering rules) may be applied to the differences. As another option, the signatures may be utilized to determine a status of a data object associated with the differences. Optionally, the status may indicate the data object as being known malicious, potentially malicious, known benign, trusted, untrusted, unwanted, potentially unwanted, etc. For example, the signatures may identify a data object associated with the differences as being a known malicious data object.

As shown in operation 416, suspicious data objects are identified and reported and the original master boot record is restored. Optionally, the data objects associated with the differences may be identified as suspicious data objects. As yet another option, the data objects remaining after the differences are processed with the filtering rules may be identified as suspicious data objects. For example, the suspicious data objects may be blocked from loading in the host operating system (e.g. as a result of the suspicious data objects being renamed). Still yet, as another option, the data objects identified as malicious, potentially malicious, untrusted, unwanted, etc. by utilizing signatures may be identified as suspicious data objects. For example, a scanner may scan the data objects associated with the differences to identify the data object as malicious.

Additionally, as noted above, the suspicious data objects are reported. As an option, the reporting may include indicating the suspicious data objects. Optionally, reporting the suspicious data objects may include listing the suspicious data objects, emailing the suspicious data objects, communicating the suspicious data objects, displaying the suspicious data objects, etc. For example, after the suspicious data objects are identified, the suspicious data objects may be displayed for a user to review. Additionally, as another option, the reporting may include reporting the suspicious data objects to a security system of the host operating system.

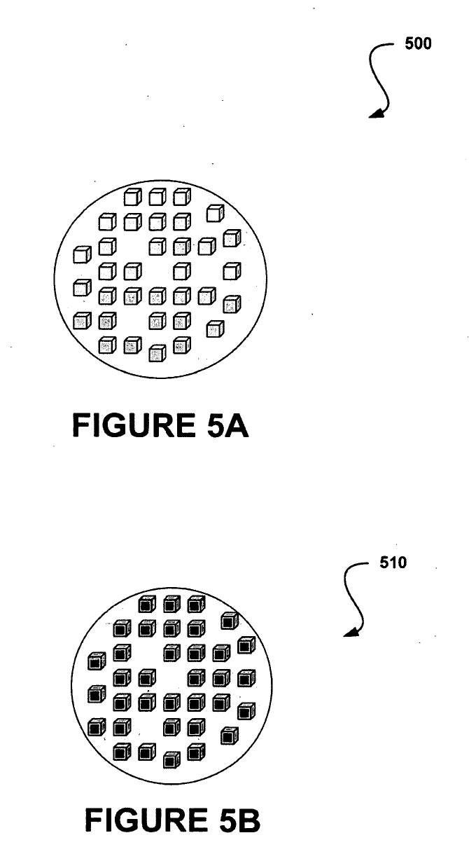

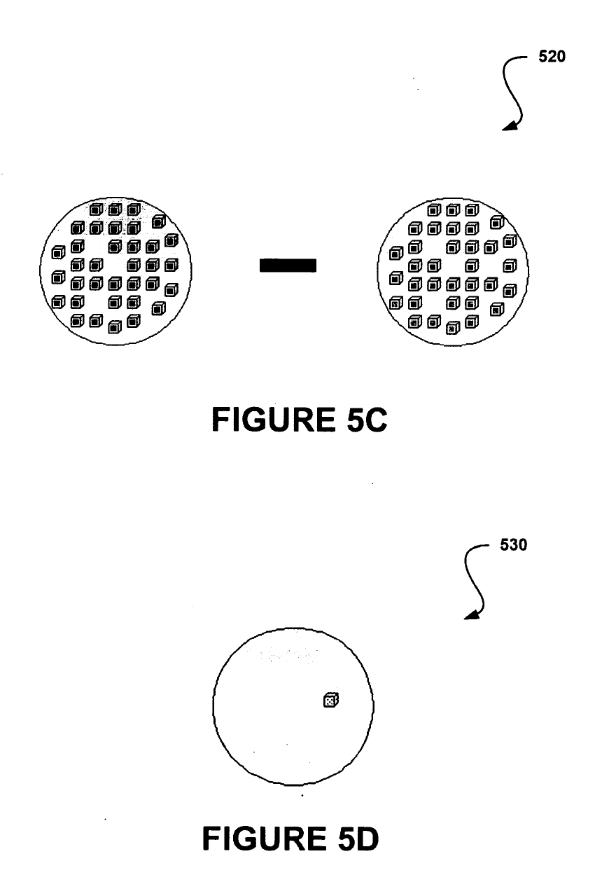

FIG. 5A illustrates a first set of data objects 500, in accordance with yet another embodiment. As an option, the first set of data objects 500 may be implemented in the context of the architecture and environment of FIGS. 1-4. Of course, however, the first set of data objects 500 may be implemented in any desired environment. Again, it should be noted that the aforementioned definitions may apply during the present description.

In one embodiment, data objects stored in a device may be enumerated. As an option, the results of the enumeration may include the first set of data objects 500. With respect to the present embodiment, the enumeration may be performed within a first operating system. For example, the first set of data objects 500 may indicate every data object located on the device which is known, readable, detectable, etc. by the first operating system. As yet another example, as illustrated in FIG. 5A, the enumeration within the first operating system of the data objects stored in the device may result in a first set of data objects including 34 data objects.

FIG. 5B illustrates a second set of data objects 510, in accordance with still yet another embodiment. As an option, the second set of data objects 510 may be implemented in the context of the architecture and environment of FIGS. 14. Of course, however, the second set of data objects 510 may be implemented in any desired environment. Yet again, it should be noted that the aforementioned definitions may apply during the present description.

In one embodiment, data objects stored in a device may be enumerated. As an option, the results of the enumeration may include the second set of data objects 510. With respect to the present embodiment, the enumeration may be performed within a second operating system. For example, the second set of data objects 510 may indicate every data object located on the device which is known, readable, detectable, etc by the second operating system. As yet another example, as illustrated in FIG. 5B, the enumeration within the second operating system of the data objects stored in the device may result in a second set of data objects including 35 data objects.

FIG. 5C illustrates a comparison 520 of a second set of data objects with a first set of data objects, in accordance with another embodiment. As an option, the comparison 520 of the second set of data objects with the first set of data objects may be implemented in the context of the architecture and environment of FIGS. 1-5B. Of course, however, the comparison 520 of the second set of data objects with the first set of data objects may be implemented in any desired environment. Again, it should be noted that the aforementioned definitions may apply during the present description.

In yet another embodiment, the second set of data objects and the first set of data objects may be compared to identify data objects that are different. Optionally, the different data objects may include data objects that are modified and/or missing in the first set of data objects when compared to the second set of data objects. For example, as illustrated in FIG. 5C, each of the data objects in the first set of data objects may be compared to each of the data objects in the second set of data objects.

FIG. 5D illustrates a result 530 of comparing a second set of data objects with a first set of data objects, in accordance with yet another embodiment. As an option, tie result 530 of comparing the second set of data objects with the first set of data objects may be implemented in the context of the architecture and environment of FIGS. 1-5C. Of course, however, the result 530 of comparing the second set of data objects with the first set of data objects may be implemented in any desired environment. It should also be noted that the aforementioned definitions may apply during the present description.

In still yet another embodiment, the result 530 may include the data objects that are different in the first set of data objects when compared to the second set of data objects. Optionally, the different data objects may include data objects which are changed and/or modified in the first set of data objects when compared to the second set of data objects. For example, as illustrated in FIG. 5D, one data object may be hidden in the first set of data objects, as enumerated within a first operating system, whereas the one data object may be included in the second set of data objects, as enumerated within a second operating system. With respect to the current example, the one data object hidden in the first set of data objects may therefore be indicated as a suspect hidden data file.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer program product embodied on a non-transitory tangible computer readable medium, comprising:
computer code for enumerating a first set of data objects stored in a first device to generate a first enumeration result, the enumeration of the first set of data objects performed within an operating system of the first device;
computer code for storing the first result in a storage medium associated with a second device different from the first device;
computer code for enumerating a second set of data objects stored in the first device to generate a second enumeration result, the enumeration of the second set of data objects performed outside of the operating system of the first device; and
computer code for comparing the first set of data objects of the first enumeration result and the second set of data objects of the second enumeration result for identifying hidden or modified data objects;
computer code for identifying at least potential unwanted data objects if it is determined based on the comparison that the first set of data objects is different from the second set of data objects, wherein the at least potentially unwanted data objects include data objects that are different between the first set of data objects and the second set of data objects; and
computer code for reporting the at least potentially unwanted data objects, wherein the reporting excludes the at least potentially unwanted data objects that are of a predetermined type.

2. The computer program product of claim 1, wherein the data objects include at least one of files and file contents.

3. The computer program product of claim 1, wherein the computer program product is operable such that the first set of data objects and the second set of data objects are enumerated by scanning data objects of the device.

4. The computer program product of claim 1, wherein the computer program product is operable such that performing the enumeration of the second set of data objects outside of the operating system includes performing the enumeration of the second set of data objects within another operating system.

5. The computer program product of claim 1, further comprising computer code for automatically booting into an environment outside of the operating system of the device in response to the enumeration of the first set of data records, for performing the enumeration of the second set of data objects.

6. The computer program product of claim 5, wherein the computer program product is operable such that the environment outside of the operating system of the device is automatically booted into by overwriting a master boot record of the device.

7. The computer program product of claim 5, wherein the computer program product is operable such that the environment outside of the operating system of the first device is automatically booted into by loading the environment outside of the operating system of the first device utilizing a network.

8. The computer program product of claim 1, wherein the computer program product is operable such that the comparison is performed outside of the operating system of the first device.

9. The computer program product of claim 1, further comprising computer code for automatically booting the operating system of the first device, based on the comparison.

10. The computer program product of claim 1, wherein the computer program product is operable such that the enumeration of the first set of data objects and the enumeration of the second set of data objects is performed at a predetermined level of abstraction of the first device.

11. The computer program product of claim 10, wherein the predefined level of abstraction includes a directory level, such that the first set of data objects includes a first directory of the first device and the second set of data objects includes a second directory of the first device.

12. The computer program product of claim 10, wherein the predefined level of abstraction includes a sector level, such that the first set of data objects includes a first set of sectors of the first device and the second set of data objects includes a second set of sectors of the first device.

13. The computer program product of claim 10, wherein the predefined level of abstraction includes a bit level, such that the first set of data objects includes a first set of bits of the first device and the second set of data objects includes a second set of bits of the first device.

14. The computer program product of claim 1, wherein the computer program products is operable such that the enumerating of the first set of data objects, the enumerating of the second set of data objects, and the comparison are performed by a security system.

15. (canceled)

16. The computer program product of claim 1, further comprising:
computer code for scanning the at least potentially unwanted data objects with signatures of known unwanted data for determining whether the at least potentially unwanted data objects are unwanted; and
computer code for reporting unwanted data objects identified as a result of the determination.

17. (canceled)

18. The computer program product of claim 1, wherein the predetermined type includes at least one of cached data objects and temporary data objects.

19. A method, comprising:
enumerating a first set of data objects stored in a first device to generate a first enumeration result, the enumeration of the first set of data objects performed within an operating system of the first device;
storing the first result in a storage medium associated with a second device different from the first device;
enumerating a second set of data objects stored in the first device to generate a second enumeration result, the enumeration of the second set of data objects performed outside of the operating system of the first device;
comparing the first set of data objects of the first enumeration result and the second set of data objects of the second enumeration result for identifying hidden or modified data objects;
identifying at least potential unwanted data objects if it is determined based on the comparison that the first set of data objects is different from the second set of data objects, wherein the at least potentially unwanted data objects include data objects that are different between the first set of data objects and the second set of data objects; and
reporting the at least potentially unwanted data objects, wherein the reporting excludes the at least potentially unwanted data objects that are of a predetermined type.

20. A system, comprising:
a processor for:
enumerating a first set of data objects stored in a first device to generate a first enumeration result, the enumeration of the first set of data objects performed within an operating system of the first device;
storing the first result in a storage medium associated with a second device different from the first device;
enumerating a second set of data objects stored in the first device to generate a second enumeration result, the enumeration of the second set of data objects performed outside of the operating system of the first device;
comparing the first set of data objects of the first enumeration result and the second set of data objects of the second enumeration result for identifying hidden or modified data objects;
identifying at least potential unwanted data objects if it is determined based on the comparison that the first set of data objects is different from the second set of data objects, wherein the at least potentially unwanted data objects include data objects that are different between the first set of data objects and the second set of data objects; and
reporting the at least potentially unwanted data objects, wherein the reporting excludes the at least potentially unwanted data objects that are of a predetermined type.

21. The system of claim 20, wherein the processor is coupled to memory via a bus.
